(19) United States
(12) Patent Application Publication
(10) Pub. No.: US 2014/0029186 A1
(43) Pub. Date: Jan. 30, 2014

(54) Portable Teleprompting Computer Console

(71) Applicant: Kevin Brinn, Los Angeles, CA (US)

(72) Inventor: Kevin Brinn, Los Angeles, CA (US)

(21) Appl. No.: 13/557,492

(22) Filed: Jul. 25, 2012

(51) Int. Cl. G06F 1/16

(52) U.S. Cl. 361/679.09; 361/679.55; 361/679.4; 361/679.27; 361/679.33

(57) ABSTRACT

A portable teleprompting computer console, specifically-designed for the use of teleprompting software and the external display of scrolling teleprompting text, specifically for use on-location, in-the-field, and for remote film and television productions.

### BACKGROUND OF THE INVENTION

Teleprompting has been at the forefront of the personal method of information dissemination for over 50 years. Like so many other technical facets of the broadcasting industry, it has experienced a flood of technological updates, making it more portable and versatile than ever before. Every teleprompter or set of teleprompters that display scrolling text to an individual has a teleprompter operating station from which the text originates. The operating station consists of a computer and accompanying equipment that allows the text to be controlled, altered, and revised by a teleprompter operator. Teleprompters have become more compact, and simpler and faster to set up over the years, yet these operating stations have changed very little beyond basic computer progression.

Though basic evolutions, such as smaller, more energy-efficient laptops and the USB interface, have become part of general computing and computing in teleprompting, a teleprompter operator or tech is still required to set up and connect the same amount of components beyond the simple laptop as they did 20 years ago, including: a video signal converter; hand controller; external monitor; video signal distribution amplifier; a number of power adapters, and power strip. Many times, more additional hardware is required, because modern laptops lack many features, they sported in the past, that are still currently required for teleprompting. This interface requires additional transport space for all of these components, not to mention the needlessly-wasted time of setting up, tearing down, and resetting up of what is an unchanging configuration.

Software installation for all these components can also be tedious. Due to the expense of software and hardware development, software piracy is a serious issue in the teleprompting industry. This leads to clumsy solutions, such as registration codes and USB dongles, being required for software installation, which are easily lost or misplaced.

Finally, each component of the interface is also powered separately, making the powering of the station through battery power difficult and very electrically-inefficient in general.

### BRIEF SUMMARY OF THE INVENTION

The known teleprompting operating stations are not readily portable, require repetitive setup, and are not energy efficient. The present inventor has recognized what is needed to solve the aforementioned problems is to provide teleprompter operators and technicians with a computer console that takes all of the required components of a teleprompting station, and combines them into a single unit that can be easily connected to a battery power from a single source. In accordance with the invention, the portability, set up, and energy efficient use of teleprompter operating stations is enhanced by utilizing a portable teleprompting computer console containing devices or keys allowing for hand control of a teleprompter that operates off of a single power source.

In particular embodiments of the invention, there may be a slightly recessed scroll wheel used for controlling the speed of the scrolling text, and four teleprompting functionality buttons that allow operators to jump to different points in the script instantly, deactivate external display, etc. With these embodiments, it may be required to insert a raised hinge block, taller than what is found on standard laptops and a screen guard extension, to allow the screen to close completely to protect all interface devices within the computer when the lid is closed.

Also, in particular embodiments of the invention, the computer may have a BNC video port, the broadcast industry standard no longer found on consumer video electronics, to provide an analog video signal and a VGA monitor port to send video to an external display.

Also, in particular embodiments, the power source may be 12 VDC 4 pin XLR connector that can connect the invention to wall power via a power adapter or directly to a battery power source to provide teleprompter operators and techs with an efficient and cohesive solution for long-term battery power.

Also, in particular embodiments of the invention, the computer may have a laptop-style base, with bumper feet connected to the side and bottom to prevent scratching and vibration damage.

### BRIEF DESCRIPTION OF DRAWINGS

FIG. 1 is an overhead diagram depicting the most common type of teleprompter operating system used in the entertainment industry.

FIG. 2 is a schematic block diagram illustrating how the equipment depicted in FIG. 1 is connected.

FIG. 3 is a perspective diagram depicting a portable teleprompting computer console embodying the principles of the present invention.

FIG. 4 is a side diagram illustrating space allocation adjustments for particular embodiments of the present invention.

FIG. 5 is a rear diagram illustrating basic operation and connection ports for particular embodiments of the present invention.

FIG. 6 is a schematic block diagram illustrating all internal and external components for particular embodiments of the present invention and how they are connected.

### DETAILED DESCRIPTION OF THE INVENTION

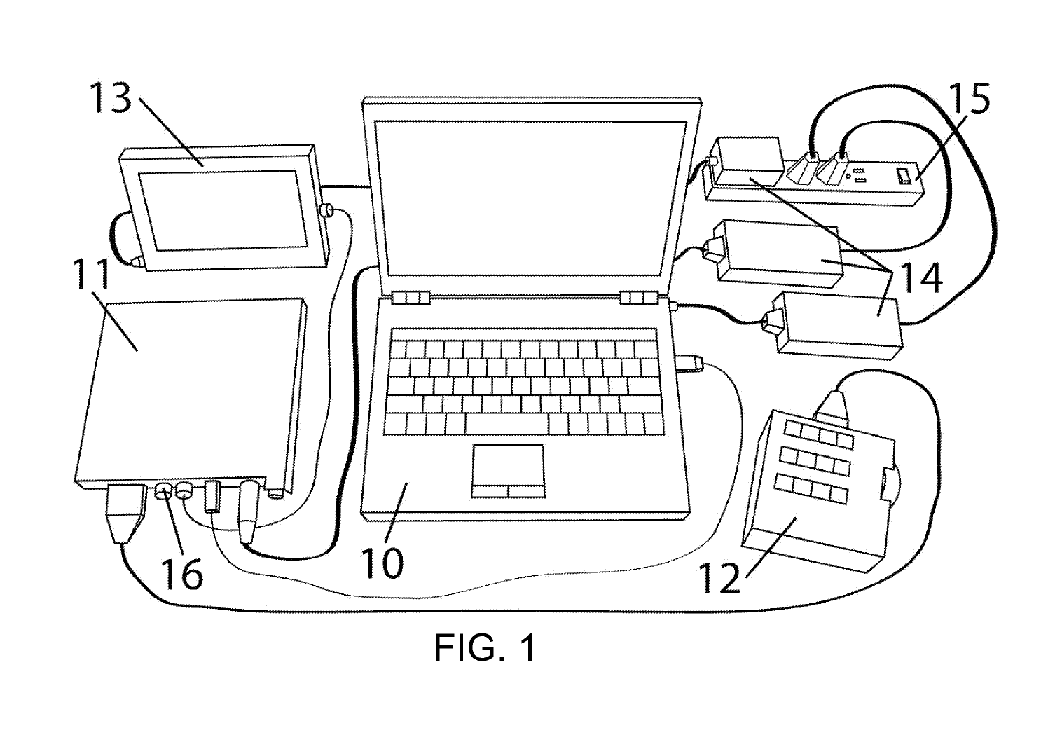

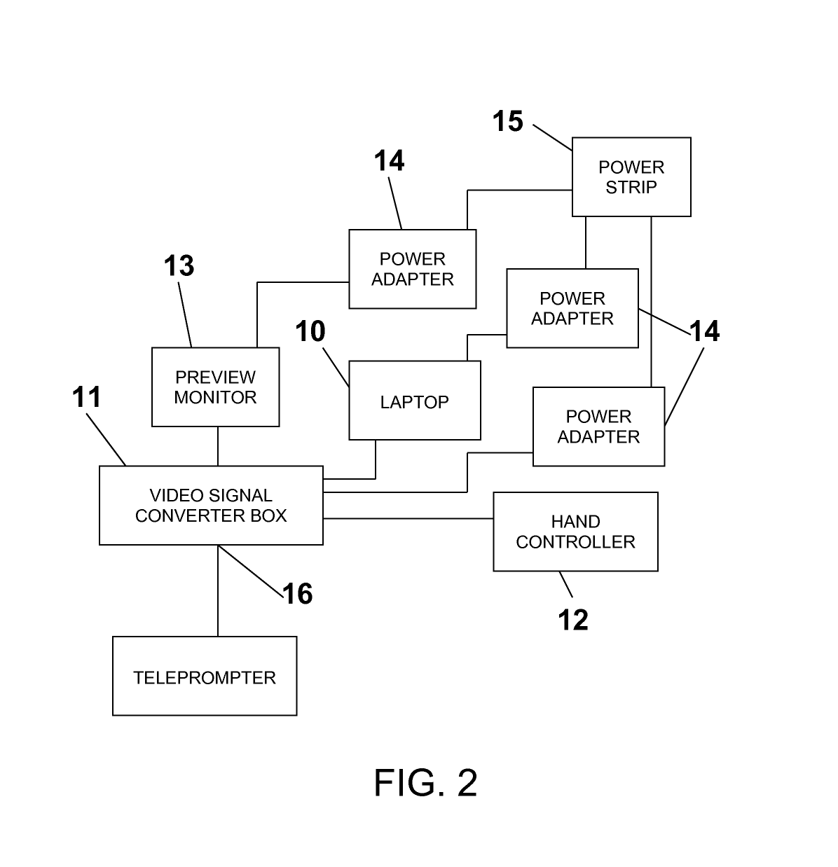

The most common type of teleprompter operating system used in the entertainment industry and its setup is depicted in FIG. 1 and FIG. 2. FIG. 1 comprises a laptop 10, a video signal connector/converter box 11, a teleprompter hand controller 12, a preview monitor 13, multiple power adapters 14, and a power strip 15. A number of proprietary connectors and cables connect each component to one another as necessary, including a BNC video connector 16 that connects the station to the teleprompter. FIG. 2 illustrates how the laptop is connected to the conversion box via a USB cable, and the conversion box is then connected to the hand controller via a Serial cable and connected to both the teleprompter and the preview monitor via BNC cables. All devices are connected to their own individual power adapters, which are then connected to a power strip, which connects to and only to AC-type wall power. Said power strip is the only current method by which all electricity for the station can be consolidated into a single power source. The known teleprompting operating stations are not readily portable, require repetitive setup, and are not energy efficient. As noted above, it remained for the present inventor to recognize that making a portable teleprompting computer console would provide numerous benefits, as detailed hereinabove.

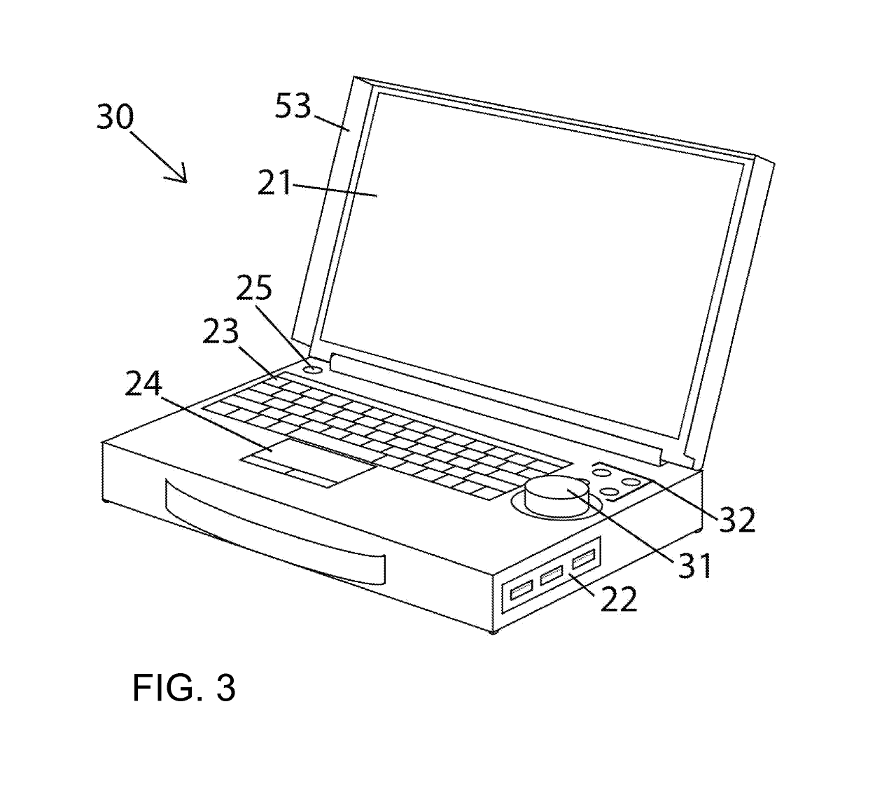

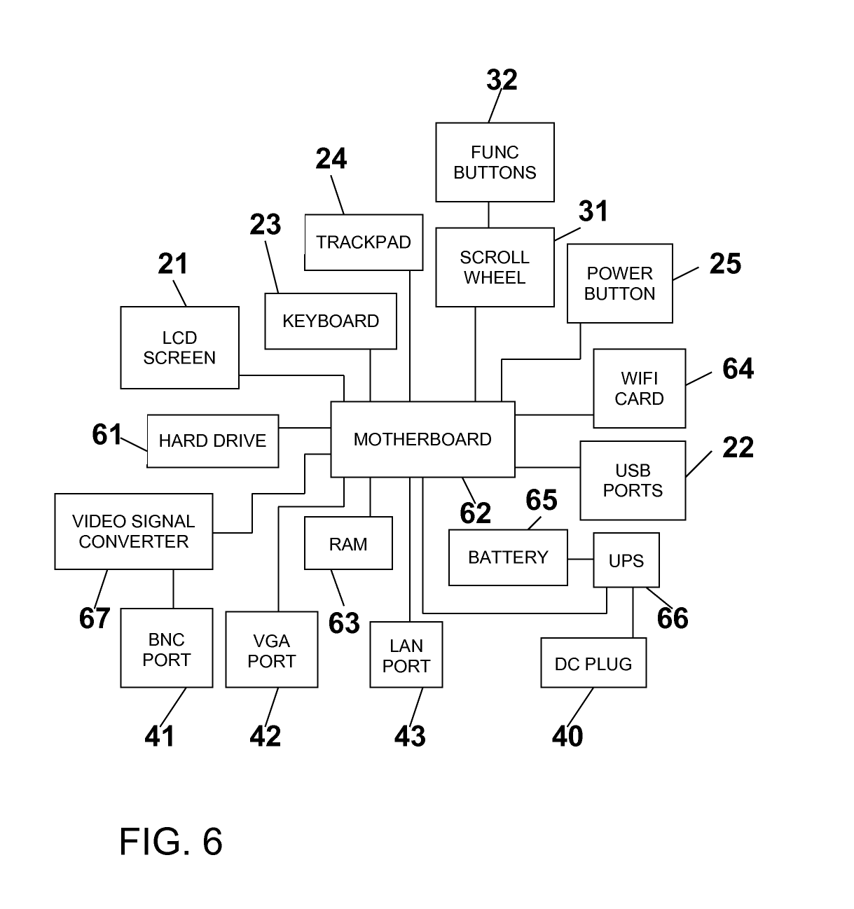

FIG. 3 depicts a portable teleprompting computer console embodying the principles of the present invention 30 with all standard external human-interface components of a laptop, including a fold-down LCD screen 21, USB ports 22, keyboard 23, trackpad 24, and power/reset button 25, that is more portable, does not require repetitive setup, and is more energy efficient than those known in the prior art. The detailed schematic of FIG. 6 identifies these same external components as well as standard internal laptop components such as hard drive 61, motherboard 62, RAM 63, and wireless fidelity internet and networking card 64.

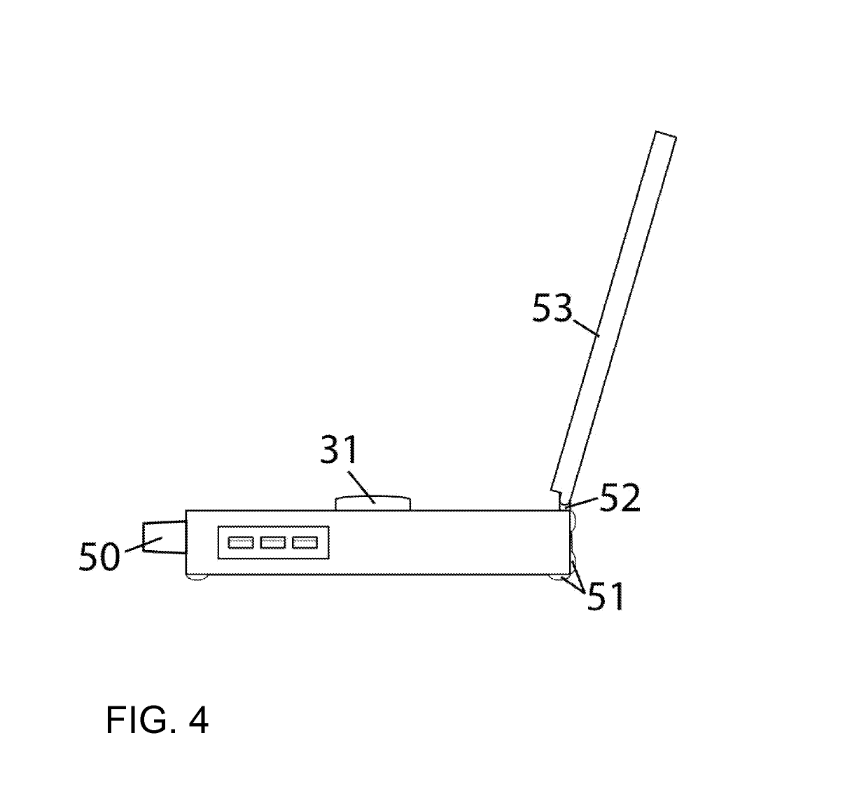

The present inventor has discovered that it would be more time and energy efficient to have a portable teleprompting computer console that includes built-in elements of a basic teleprompter hand controller. In accordance with an advantageous feature of the invention, and as can be seen in FIG. 1 and FIG. 6, the external human-interface components of particular embodiments of the present invention may include a slightly recessed scroll wheel 31 used for controlling the speed of the scrolling text on a teleprompter, and four teleprompting functionality buttons 32 that allow operators to jump to different points in the script instantly, deactivate external display, etc. With these embodiments, FIG. 4 illustrates, from a side view, how the scroll wheel 31 extends slightly above the surface for accessibility, requiring a raised hinge block 52 taller than found on standard laptops to allow the screen to close completely, as well as a screen guard extension 53 (as also seen in FIG. 1) to protect all interface devices within when the lid is closed.

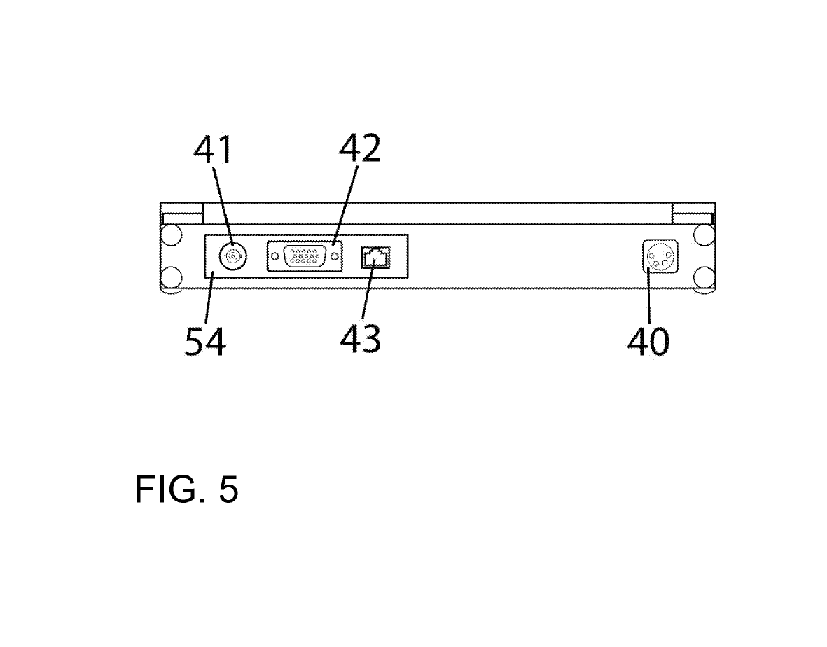

The present inventor has also discovered that energy efficiency of a teleprompter operating station will be enhanced by providing teleprompter operators and techs with an efficient and cohesive solution for long-term battery power. The problem is solved in this embodiment, as illustrated in FIG. 5, by using a 12 VDC 4 pin XLR connector 40 that can connect this embodiment of the invention to wall power via a power adapter or directly to a battery power source.

The present inventor has also discovered that damage from scratching and vibration may occur when the present invention is used or transported. The problem is solved in this embodiment, as illustrated in FIG. 4, by placing rubber bumper feet 51 at the corners of both the bottom and the rear of this embodiment of the invention to prevent scratching and vibration damage, and by attaching a carrying strap 50 that allows this embodiment of the invention to be carried by a single hand.

The present inventor has also discovered that power may be lost when the present invention is in use. The problem is solved in this embodiment, as illustrated in FIG. 6, by including a short-use internal battery, and a Universal Power Supply battery backup circuit 66 to control power-switching for the internal battery, for backup, in case of power loss.

The foregoing merely illustrates the principle of the invention, and it will thus be appreciated that those skilled in the art will be able to devise numerous alternative arrangements that, while not shown or described herein, embody the principles of the invention and thus are within its spirit and scope.

What is claimed is:

1. An apparatus comprising;
A portable teleprompting computer console;
Means for allowing hand control of a teleprompter; and
Means for connection to a single power source.

2. The computer console of claim 1 comprising;
A recessed scroll wheel integrated into the top of said base; and
Teleprompting functionality buttons integrated into the top of said base just above the scroll wheel.

3. The computer console of claim 1 comprising;
A BNC video port integrated into the back of said base; and
A VGA monitor port integrated into the back of said base.

4. The computer console of claim 1 comprising a 4-PIN XLR power connecter integrated into the back of said base.

5. The computer console of claim 1 comprising;
An extra-tall hinge structure connected to top of said base;
An LCD display screen connected to said hinge structure; and
A guard extension connected to the perimeter of said display screen.

6. The computer console of claim 1 comprising;
A laptop style base; and
Bumper feet connected to the side and bottom of said base.

7. The computer console of claim 1 wherein the interior is a short-use backup battery.

8. The interior of the computer console of claim 1 wherein there is interface circuitry connecting the scroll wheel and functionality buttons of claim 2 to the motherboard of the computer console.

9. The interior of the computer console of claim 1 wherein a display conversion circuitry is connecting the motherboard of the computer console to the BNC and VGA ports of claim 3.

10. The interior of the computer console of claim 1 wherein the UPS battery backup switching circuitry is connected to the battery of claim 4 and the motherboard of the computer console.

11. The base of the computer console of claim 1 wherein;
A keyboard and trackpad are integrated into the top of said base;
A power button is integrated into the top of said base;
USB ports are integrated into the side of said base; and
An Ethernet LAN port is integrated into the back of said base.

12. The computer console of claim 1 wherein the motherboard and CPU are connected to;
The keyboard and trackpad of claim 11;
The USB ports of claim 11 and;
The Ethernet LAN port of claim 11.

13. The computer console of claim 1 wherein the motherboard and CPU is connected to;
A hard drive;
RAM memory; and
A wireless fidelity internet and networking card.
